(19) United States
(12) Patent Application Publication
(10) Pub. No.: US 2020/0412206 A1
(43) Pub. Date: Dec. 31, 2020

(54) DUAL-FLUX ELECTRIC MACHINE

(71) Applicant: IFP Energies nouvelles, Rueil-Malmaison Cedex (FR)

(72) Inventors: Misa MILOSAVLJEVIC, RUEIL-MALMAISON CEDEX (FR); Fabrice LE BERR, RUEIL-MALMAISON CEDEX (FR)

(21) Appl. No.: 16/979,082

(22) PCT Filed: Feb. 27, 2019
(86) PCT No.: PCT/EP2019/054849

§ 371 Date: Sep. 8, 2020

(30) Foreign Application Priority Data
Mar. 8, 2018 (FR) 1852012

(51) Int. Cl. H02K 9/16; H02K 1/20; H02K 5/20; H02K 5/18; H02K 9/06; F02B 39/10; F02B 39/00

(52) U.S. Cl. CPC H02K 9/16; H02K 1/20; H02K 5/20; H02K 5/18; H02K 2213/09; F02B 39/10; F02B 39/005; F05D 2220/40; H02K 9/06

(57) ABSTRACT

The invention is an electric machine comprising a rotor (3), a stator, an outer casing (6) and stator cooling. Rotor (3) and the stator are coaxial along a longitudinal axis (xx), and the stator comprises magnetic flux generators (5). The stator cooling comprises at least two fluid circulations. At least a first circulation extends longitudinally within the stator and forms a first flow made up of flows F1A and F1B, and at least a second circulation is positioned around the periphery of the stator and forms a second flow F2. The invention also is a compressor and a turbocharger electrified with such an electric machine.

### CROSS-REFERENCE TO RELATED APPLICATIONS

Reference is made to International Application No. PCT/EP2019/054849, filed Feb. 27, 2019, which claims priority to French Patent Application No. 18/52.012, filed Mar. 8, 2018, the contents of which are incorporated herein by reference in their entirety.

### BACKGROUND OF THE INVENTION

### Field of the Invention

The present invention relates to an electric machine, in particular to an electric machine that can be used in an electrically-assisted compression device for compressing a working fluid such as a liquid fluid or a gaseous fluid.

It more notably relates to a device for compressing a gaseous fluid, such as air here, by a compressor, alone or associated with a turbine to form a turbocharger, prior to the compressed gaseous fluid to any device and, more particularly, to the intake of an internal-combustion engine.

The invention can notably prove to be relevant in the transport sector (motor or heavy-load transport for example), the aerospace sector, the power generation sector or the food industry, the petroleum industry, the construction sector or the medical/paramedical sector.

### Description of the Prior Art

Indeed, as is widely known, the power delivered by an internal-combustion engine depends on the amount of air fed to the combustion chamber of the engine, which amount of air is proportional to the density of the air.

Thus, it is usual to increase the amount of air through compression of the outside air before it is allowed into this combustion chamber when high power is required. This operation, known as turbocharging, can be carried out using any mechanism such as a compressor alone, electrically driven by an electric machine (electrified compressor), or a compressor associated with a turbine and an electric machine to form an electrified turbocharger.

In the aforementioned two cases, the electric machine associated with the compressor can be of several types.

One is an electric machine with a small air gap and windings close to the rotor, which provides optimal guidance of the magnetic flux and optimized efficiency. This type of electric machine has the advantage of a certain compactness, which may sometimes be a problem regarding cooling and requires a specific system for carrying away heat losses.

In order not to be intrusive to the air intake of the compressor, this type of electric machine is conventionally positioned on the back of the centrifugal compressor in the case of an electrified compressor, or between the compressor and the turbine in the case of an electrified turbocharger, despite the presence of an unfavourable thermal environment in the latter case, close to the turbine. Generally, the link between the compressor, the turbine and the electric machine is rigid. This type of machine can also be positioned on the compressor side, but relatively far from the air intake so as not to cause disturbance.

This type of systems is described in more detail in patents and published applications: US-2014/0,373,532, U.S. Pat. Nos. 8,157,543, 8,882,478, US-2010/0,247,342, U.S. Pat. Nos. 6,449,950, 7,360,361, EP-0,874,953 or EP-0,912,821.

The cooling systems disclosed in these patent and applications provides external cooling of the stator, which may make the system more complex in the design and integration thereof.

Another type of machine is an electric machine with a large air gap that may sometimes be several centimeters long, to allow passage of the working fluid therethrough. This permits enabling integration as close as possible to the compression systems, in a significantly more favorable thermal environment.

However, this large air gap involves a drawback regarding passage of the magnetic flux between the rotor and the stator, and therefore a limitation for the intrinsic efficiency of the machine and the size of the stator for the same power output.

This type of electric machine is notably described in patents and published applications EP-1,995,429, US-2013/169,074 or US-2013/043,745.

A new type of machine has recently appeared. It is a machine provided with a stator grid, which is described in more detail in patent applications FR-3,041,831 (WO-2017/050,577) and FR-3,048,022. This electric machine, referred to as “stator-grid” machine, comprises a rotor and a stator. The stator comprises radial passages circumferentially arranged along the stator, magnetic flux generators housed in these radial passages and a stator bearing receiving the rotor. The magnetic flux generators are coils for example. The radial passages comprise fluid circulation galleries facing the magnetic flux generators. Furthermore, the radial passages are separated by radial teeth, also referred to as “stator teeth”.

This machine affords the advantage of providing a better compromise in terms of cooling and electrical performance than the other two types of machines. However, under some operating conditions, the cooling induced by the fluid flow through the circulation galleries may prove insufficient when the fluid flow rate is set to reach an overall system performance goal, without correlation of the need for intrinsic cooling of the machine.

For all these electric machines, cooling of the stator is a major challenge for improving the lifetime of the electric machine, increasing its operating range and improving its efficiency. However, this cooling should not, in return, impact the maximum output power. Similarly, cooling should not significantly impact the cost or the size of the system. Moreover, the performance of the electric machine is very important in the performance of an electrified compressor and, a fortiori, in the case of an electrified turbocharger.

Similar problems appear for all types of electric machines.

Moreover, with electrified turbocharging system type solutions, using stator-grid electric machines may appear limiting when the rate of flow through the electric machine is high. It may generate a high pressure drop likely to reduce the overall performance of the system.

### SUMMARY OF THE INVENTION

In order to meet the aforementioned requirements, the present invention relates to an electric machine comprising a rotor, a stator, an outer casing and a cooling system for cooling the stator, the rotor and the stator being coaxial along a longitudinal axis with the stator comprising magnetic flux generators. The stator cooling system comprises at least two fluid circulations. At least a first circulation extends longitudinally within the stator and at least a second circulation is positioned around the periphery of the stator. Thus, the electric machine is provided with an effective cooling positioned as close as possible to and on either side of the magnetic flux generators, without impacting the magnetic flux or the iron losses. Furthermore, this cooling induces no significant extra cost or major change in the size of the system. This cooling is simple and it does not use a closed fluid loop that would require adding pumps and other equipments, and cause fluid consumption. Finally, it allows limiting the pressure drop generated by the machine on the fluid, by not passing all of the working fluid through the stator grid.

The invention also relates to a compression device equipped with such an electric machine and to a turbocharger electrified with this type of electric machine.

The device according to the invention relates to an electric machine comprising a rotor, a stator, an outer casing and cooling of the stator, the rotor and the stator being coaxial along a longitudinal axis, the stator comprising magnetic flux generators, in that the cooling of the stator comprises at least two fluid cooling circulations, at least a first circulation extending longitudinally within the stator and at least a second circulation positioned around the periphery of the stator.

Advantageously, the stator comprises radial passages circumferentially arranged along the stator with the radial passages being delimited by radial teeth, the magnetic flux generators being housed in the radial passages, the radial passages forming at least a first fluid passage facing the magnetic flux generators.

Preferably, the fluid is air, and more preferably air at ambient temperature taken from the ambient medium.

According to an embodiment of the invention, at least a second circulation is arranged between the magnetic flux generators and the outer casing.

According to a variant of the invention, the inlet to the at least the second circulation is radial from the at least first circulation.

Alternatively, the inlet of the at least second circulation is axial.

According to an embodiment of the invention, the outlet of the second circulation is radial.

Alternatively, the outlet of the second circulation is axial.

Advantageously, the second circulation comprises, at the outlet thereof, a substantially radial orientation of the fluid flow for mixing the fluids circulating in the at least two circulations.

Advantageously, the at least the second circulation comprises an active or passive flow regulation positioned at the inlet or at the outlet of the at least second circulation.

Preferably, the at least the second circulation comprises fins at the level of the at least second circulation, and preferably fins extending from one end to the other of the section, orthogonal to the direction of flow of the fluid, of the at least second circulation.

The invention also relates to a compression device for a gaseous or liquid fluid, comprising compression with an intake for the fluid to be compressed, an outlet for the compressed fluid, the compression of the fluid being carried by a compressor shaft and housed between the intake and the outlet, and an electric machine according to one of the above features, the electric machine being positioned upstream, in relation to the direction of flow of the fluid, from the compression.

Moreover, the invention also relates to an electrified turbocharger device comprising an expansion device and a compression device, according to one of the above features, the expansion device and the compression device being fastened to the same rotating shaft, thus allowing common rotation of the expansion device and the compression device.

### BRIEF DESCRIPTION OF THE DRAWINGS

Other features and advantages of the system according to the invention will be clear from reading the description hereafter of embodiments, given by way of non limitative example, with reference to the accompanying figures wherein:

FIG. 1 illustrates a first embodiment of an electric machine according to the invention;

FIG. 2 illustrates a second embodiment of an electric machine according to the invention;

FIG. 3 illustrates a third embodiment of an electric machine according to the invention;

FIG. 4 illustrates a fourth embodiment of an electric machine according to the invention;

FIG. 5 illustrates a fifth embodiment of an electric machine according to the invention;

FIG. 6 schematically illustrates an electrified compression device according to the invention; and

FIG. 7 schematically illustrates an electrified turbocharger device according to the invention.

### DETAILED DESCRIPTION OF THE INVENTION

The invention relates to an electric machine comprising a rotor, a stator, an outer casing and stator cooling means of a cooling device. The rotor and the stator are used to generate an electric current (“generator” mode of the electric machine) or to drive the rotor in rotation from an electric current (“motor” mode of the electric machine). The purpose of the outer casing, which is also simply referred to as casing, is to protect the internal equipments of the machine, including the rotor and the stator, against external aggressions (splash water for example) and to protect the user from electrical hazards and from the so-called “rotary machine” risks related to the electric machine. The rotor and the stator are coaxial, along a longitudinal axis, which allows rotation of the rotor in the stator. The stator comprises magnetic flux generators, coils for example. When the electric machine operates in “motor” mode, the magnetic flux generators create a magnetic flux driving the rotor, equipped with magnetic receivers such as permanent magnets, in rotation. When the machine operates in “generator” mode, the rotation of the rotor and, therefore, of its permanent magnets generates an induced electric current in the magnetic flux generators (thus operating as a receiver).

The cooling means or device is used to cool the machine so that it can operate over optimal temperature ranges. Thus, the life of the electric machine and the efficiency thereof are increased. The performance of the electric machine is also improved.

The cooling means comprises at least two fluid circulation means or devices.

At least a first circulation means or device extends longitudinally in the stator (within the stator). The fluid thus passes completely through the stator in the longitudinal direction, making it possible to capture a large part of the thermal losses of the electric machine stator, possibly by means of the stator grid.

At least a second circulation means or device is positioned around the periphery of the stator. When the rotor is positioned in the stator, at least a second circulation means or device is then positioned outside the stator, between the stator and the outer casing. This second circulating fluid flow passes as close as possible to the magnetic flux generators, which improves cooling thereof and therefore increases the performance and the efficiency of the electric machine. If possible, only a wall separates the second circulating fluid flow from the magnetic flux generators, the wall preventing direct contact between the fluid and the magnetic flux generators.

The at least two circulation operates in open circuits. Thus, no pump, pipe and secondary equipment required for closed-loop circulation is necessary. When the at least two fluid circulations are separated only by the magnetic flux generators, i.e. when the fluid circulation means or device are located on either side of the magnetic flux generators to pass as close as possible to the magnetic flux generators, the efficiency of the cooling is improved.

This configuration of the cooling with at least two fluid circulations is particularly interesting. It allows increasing the fluid passage section in relation to a configuration where only one or the other fluid circulation is used, without increasing the air gap. By increasing the passage section, the fluid flow rate can thus be increased without inducing additional pressure drops. On the other hand, in a configuration where only one of the two fluid circulations is used, the increase in the fluid passage section would be greater and would require a more significant increase in the overall size of the machine. As a result, the flow of fluid passing through the machine would then be limited because of the pressure drops.

Increasing the flow of fluid in the electric machine allows its intrinsic cooling to be improved. Furthermore, by dividing the fluid circulation into at least two parts, one inside the stator and at least another part on the outer periphery thereof, and more particularly if the circulating flow passes on either side of the magnetic flux generators, the cooling effectiveness is improved. It is then possible, for the same machine size, to increase its power or, for a machine of same power, to make it more compact. Furthermore, the temperature reduction of the flux generators allows reduction of their resistance and therefore the Joule losses, which further improves the efficiency.

This cooling is particularly relevant when a compressor for example is used downstream from the electric machine. Indeed, increasing the flow rate reaching the compressor inlet without impacting the pressure drops in the electric machine allows the compressor performance to be improved. A compression device electrified by such a machine, and a fortiori an electrified turbocharger device, thus represents a significant performance gain by synergy between the gains obtained on the electric machine and those obtained by the compression means.

Here, the present invention concerns all types of electric machines, including machines with a stator grid and machine with a large air gap.

According to an embodiment of the electric machine according to the invention, the stator can comprise radial passages circumferentially arranged along the stator which are cylindrical or substantially cylindrical. The radial passages can be delimited by radial teeth, and magnetic flux generators can be housed in the radial passages. The radial passages thus form at least a first fluid passage facing the magnetic flux generators (coils for example). In this case, the electric machine is a stator-grid electric machine.

The cooling comprises at least two circulations as defined above which is particularly suited to a stator-grid electric machine. Indeed, the stator-grid electric machine is designed to allow a significant flow of fluid within the stator. At least a second circulation, located on the periphery of the stator which is preferably between the magnetic flux generators and the outer casing, allows further improvement in cooling, for example, during an operation inducing a strong current in the magnetic flux generators, and therefore significant Joule losses. This additional cooling also makes it possible to improve the life of the electric machine, as well as the efficiency of the electric machine by reducing the temperature and therefore the resistance of the flux generators.

Moreover, since the flow rate is already high in the stator due to the configuration of the stator-grid machine, the passage section of the second circulation can be reduced, which limits space constraints. With this second circulation, it is possible to reduce the passage section within the stator, which limits space constraints and the amount of materials used in the stator. This provides a reduction in the cost of the system as well as a reduction in iron losses in view of the electric machine comprising less ferric material.

Preferably, the fluid can be air which is preferably air taken from the ambient medium. There is therefore no need for consumption of a dedicated fluid, which on the one hand reduces the cost of the cooling and, on the other, avoids the use of pumps, tanks, pipes and other secondary equipments that would impact the cost and involve risks of failure.

According to a variant of the invention, at least a second circulation can be located between the magnetic flux generators and the outer casing. Thus, fluid circulation is as close as possible to the magnetic flux generators which provides improved cooling.

Preferably, at least a second circulation can be an annular space, for example between the outside diameter of the magnetic flux generators and the inside diameter of the outer casing.

This at least second circulation can also be a set of longitudinal spaces of circular section, in form of inserted tubes or bores in a metallic mass. These spaces are preferably evenly distributed around the magnetic flux generators in order to carry off the thermal energy as homogeneously as possible.

According to an embodiment of the machine according to the invention, the shape of the stator, the rotor and the outer casing can be cylindrical, substantially cylindrical or annular. The inlet to the second circulation can be radial from the first circulation. In this case, the flow passing into the machine is partly diverted. Part of the flow continues longitudinally and passes through the stator, and the diverted part enters at least a second circulation radially. The flow distribution is achieved passively via the pressure difference upstream/downstream from the electric machine. This configuration allows the design of the machine to be simplified with a single air inlet instead of two separate inlets.

Alternatively, the inlet to at least a second circulation can be axial. In this case, the electric machine has two separate air inlets. The fluid inflows through these two air inlets may or may not come from the same fluid stream upstream from the electric machine. The axial inlet is interesting because it allows reduction of pressure losses in relation to a radial inlet.

According to a variant of the system according to the invention, the outlet of at least a second circulation can be radial. The junction of the flows leaving at least a first circulation and at least a second circulation can thereby occur before the fluid leaves the electric machine which homogenizes the outlet flow.

Alternatively, the outlet of at least a second circulation can be axial. In this case, the electric machine has two separate air outlets. These two air outlets may or may not join in the same fluid stream downstream from the electric machine. The axial outlet is interesting because it allows reduction of pressure losses.

Advantageously, at least a second circulation can comprise, at the outlet thereof, a means for providing a substantially radial orientation of the fluid flow for mixing the fluids circulating in at least two circulations. The function of this substantially radial orientation is to orient the circulating fluid flow to impart a rotational motion thereto, referred to as pre-rotation, about the longitudinal axis of the electric machine. This function is particularly interesting when a compressor is used downstream, in the direction of circulation of the fluid, from the electric machine. Indeed, the pre-rotational motion of the fluid allows the operating range of the compressor to be modified by increasing the use area thereof, notably towards low flow rates and high compression ratios. The compression ratio is the ratio of the compressor outlet pressure to the compressor inlet pressure. This substantially radial orientation can for example be blades or parts substantially or partly resembling blades. It can also be circular parts as for example a circular rotating part and a circular stationary part with at least one of the two parts being perforated so that, during rotation, the perforation opens more or less so as to be alternately totally open, partly closed, totally closed, partly open, totally open, etc.

Advantageously, at least a second circulation can comprise an active or passive flow regulation means or device positioned at the inlet or at the outlet of at least a second circulation. This regulation allows or prevents circulation in the second circulation. This improves operation of the machine by avoiding passage when it is not relevant. When useful, in particular in case of high flow rates or in order to modify the orientation of the flow downstream from the electric machine, either control of the flow regulation provides a suitable opening (active flow regulation), or the pressure drop generated in this flow regulation causes part of the flow to pass into the second circulation (passive flow regulation). The passive flow regulation has the advantage of having a low cost and it requires no control. The passive flow regulation can for example be one or more calibrated openings, calibrated holes for example. It can also consist of a relevant orientation at the inlet to the second circulation, which generates a suitable pressure drop causing the fluid to pass into the first circulation up to a given flow rate. On the other hand, the active system provides flow regulation and more suitable operation. It can be an “on-off” valve, a regulation valve of ball valve type or a set of blades for example.

Preferably, at least a second circulation can comprise fins at the level of the second circulation. The fins increase the heat exchange surface area and thus improve cooling of the machine.

Preferably, fins can extend from one end to the other end of the section and be orthogonal to the direction of flow of the fluid, of the second circulation. For example, when the stator and the outer casing are cylindrical, the fins can extend from the outside diameter of the stator to the inside diameter of the outer casing. Thus, the heat exchange surface area is improved.

The invention also relates to a compression device for a gaseous or liquid fluid, comprising a compression with an intake for the fluid to be compressed and a compressed fluid outlet. The fluid compressor is carried by a compressor shaft and housed between the intake and the outlet. The device comprises an electric machine according to at least one of the above features. The electric machine can then be positioned upstream, in relation to the direction of flow of the fluid, from the compressor. Using an electric machine as described above allows the performance of the electric compressor to be improved, through improved performance of the electric machine, increased flow rate at the compressor inlet and modification of the operating range of the compressor to increase the use area thereof, notably to low flow rates and high compression ratios, using pre-rotation for example. Pre-rotation, in the opposite direction, also allows the operating range of the compressor to be extended to high flow rates.

The invention further relates to an electrified turbocharger device comprising an expansion means or device and a compression device as described above. The expansion means or device and the compression device are then fastened to the same rotating shaft, thus allowing common rotation of the expansion means or device and of the compressor. The improvements brought to the electrified compressor with one of the above features allow the performance of the electrified turbocharger to be improved.

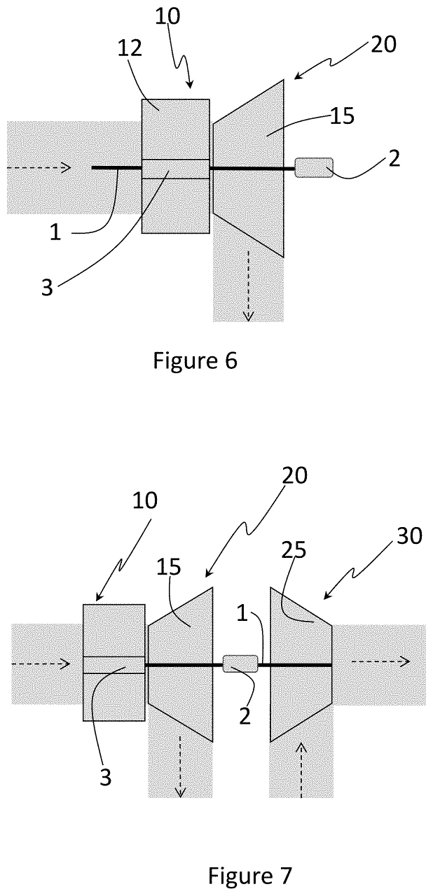

FIG. 6 schematically shows, by way of non-limitative example, an example of an electrified compression device in form of an electrified compressor 20 according to the invention. The system comprises a rotating shaft 1, an electric machine 10 and a compression means 15 (a compressor for example). Fluid flows through the system in the direction of the dotted arrows. Electric machine 10 is positioned upstream from the compressor 15 in the direction of flow of the fluid which provides more favorable thermal conditioning for cooling thereof. A guiding system 2 is used to take up the forces, notably the mass of the assembly, and also to set up bearings. Preferably, the compressor 15 is arranged downstream from electric machine 10 to be just behind electric machine 10. By being located as close as possible to electric machine 10, the compression means 15 benefits from a high air flow passing through the electric machine.

The electric machine comprises a rotor 3 and a stator 12. Stator 12 is stationary. Rotor 3 and compression means 15 rotates by a common action induced by rotating shaft 1. The magnetic field induced in electric machine 10 can generate the rotation of rotor 3 which drives rotating shaft 1, which itself drives the compression means 15. Under certain conditions, upon deceleration of the compression means, the operation can be reversed so that the rotation of compression means 15 drives rotating shaft 1, which in turn causes the rotation of rotor 3, thus generating electricity within electric machine 10.

FIG. 7 shows, by way of non-limitative example, an example of an electrified turbocharger device 30 comprising an electrified compressor 20 and an expansion means or device 25 (a turbine here). Electrified compressor 20 is identical to the compressor of FIG. 6. In electrified turbocharger 30, rotating shaft 1, which provides common rotation of electric machine 10 and of compression means 15, is extended on the other side of guiding system 2 and it also provides rotation of expansion means 25. Expansion means 25 is positioned on the side opposite to the electrified compressor with respect to guiding system 2. Other arrangements are however possible without limiting the invention.

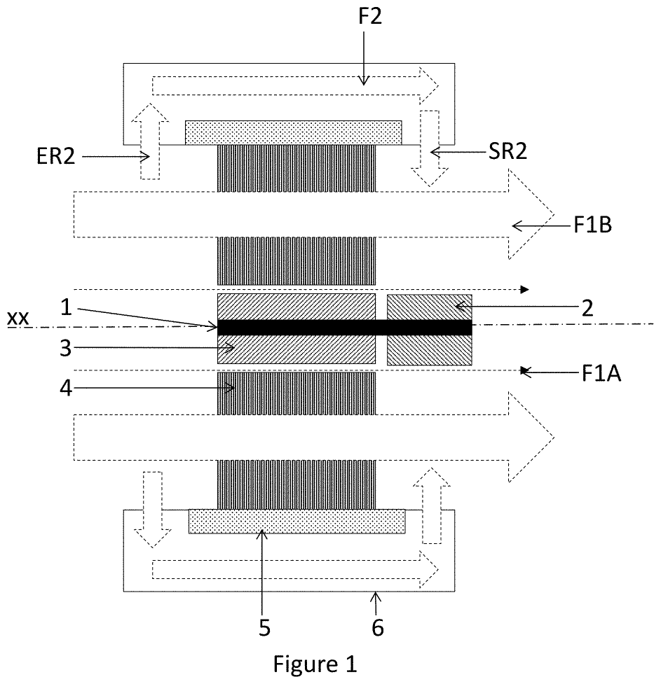

FIGS. 1 to 5 illustrate several embodiments of electric machines according to the invention, of stator-grid electric machine type. However, the invention can also be used for other types of electric machines without limitation.

Furthermore, for FIGS. 1 to 5, rotor 3, shaft 1, guiding system 2, stator grid 4, outer casing 6 and magnetic flux generators 5 form cylindrical or annular or substantially cylindrical or annular parts. In these figures, the dotted arrows show the direction of open-loop circulation of the fluid through the machine.

FIG. 1 schematically shows, by way of non-limitative example, a first embodiment of the electric machine according to the invention.

The electric machine of FIG. 1 comprises a rotating shaft 1, a guiding system 2, which can include, by way of non-limitative example, bearings, rolling bearings for guidance and connection with the auxiliary equipments, a rotor 3, a stator grid 4, magnetic flux generators 5 and an outer casing 6. Magnetic flux generators 5, which may be coils for example, are positioned in stator grid 4, in the outer peripheral part of stator grid 4. The outside diameter of magnetic flux generators 5 and that of stator grid 4 substantially merge with one another. Stator grid 4 and magnetic flux generators 5 make up the stator of the electric machine. As described in more detail in patent applications FR-3,041,831 (WO-2017/050,577) and FR-3,048,022, stator grid 4 comprises radial webs forming circulation galleries. A fluid can therefore circulate in these circulation galleries, thus forming at least a first circulation, and the fluid can thus cool magnetic flux generators 5, on the inside diameter thereof, as well as stator grid 4. The significant thermal exchange surface generated by the radial webs provides highly effective cooling of the electric machine.

Axis xx is the longitudinal axis about which rotor 3 and shaft 1 rotate. Rotor 3 is fixedly mounted on rotating shaft 1 which provides common rotation of shaft 1 and rotor 3. The stator which consists of stator grid 4 and magnetic flux generators 5, surrounds the rotor and is stationary. An air gap is located between the rotor and the stator.

A guiding system 2 is used to bear the forces, notably the mass of the electric machine, and to support bearings, which by way of non-limitative example, enable connection between rotating shaft 1 and a fixed frame (not shown).

A fluid circulates in the electric machine. This fluid is air for example, preferably taken from the ambient medium. The fluid circulation is an open-loop circulation.

In FIG. 1, the fluid flowing into the machine is divided into several flows. A first part of a first flow F1B passes directly into the circulation galleries of stator grid 4, thus forming at least a first circulation. First flow F1B can pass into the stator of another type of electric machine. A small proportion of this first flow F1A passes into the air gap which is a space formed between rotor 3 and stator grid 4.

A second circulation flow F2 is diverted from first circulation flow F1A/F1B and is sent to an inlet ER2, which is a radial inlet here, prior to passing through at least a second circulation. This second circulation is an annular section between magnetic flux generators 5 and outer casing 6. Preferably, this second circulation is close to the outside diameter of magnetic flux generators 5, which optimizes cooling thereof. This second part of the circulation flow then joins the first part of the flow, generated by flows F1A, F1B and F2, by leaving through radial outlet SR2. The flow leaving the electric machine thus is the flow reconstituted by flows F1A, F1B and F2.

It is also possible to integrate a circulation flow orientation means (not shown) on radial outlet SR2. This orientation means allows both mixing the flows from second circulation flow F2 and from the two parts of first flow F1A and F1B passing through the air gap and the stator which imparts a pre-rotation, about the axis of rotation, thereto. This pre-rotation of the flow is particularly interesting when a compression device, a fortiori a turbocharger device, is positioned behind the electric machine. Indeed, this pre-rotation of the flow at the compression device inlet allows the efficiency thereof to be increased. This pre-rotation can for example be induced by blades or pieces of blades.

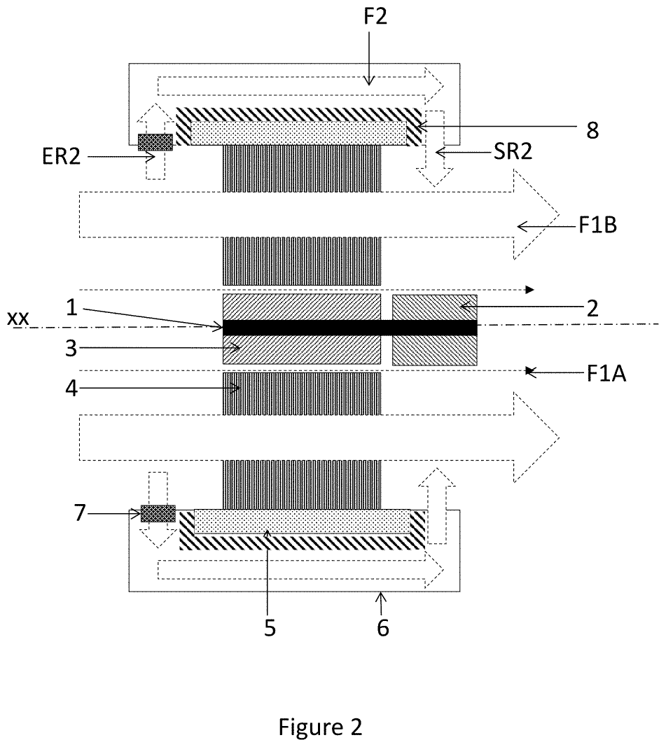

In FIGS. 2 to 5, the references as identical to FIG. 1 and fully correspond to the references of FIG. 1. They are not described in detail in these figures.

FIG. 2 schematically shows, by way of non-limitative example, a second embodiment of the system according to the invention. This embodiment differs from FIG. 1 by the addition of fins 8 positioned on the outside diameter of magnetic flux generators 5 and fins 8 positioned at both longitudinal ends, along longitudinal axis xx, of magnetic flux generators 5. These fins promote heat exchange between magnetic flux generators 5 and circulation flow F2. Fins 8 can notably be positioned from the outside diameter of magnetic flux generators 5 and extend up to the inside diameter of outer casing 6. Thus, the exchange surface area is maximal and cooling is optimal. Advantageously, it may be interesting to keep a clearance, even a small one, between fins 8 and outer casing 6 which avoids conducting heat from the outside environment to the stator of the electric machine (case of a vehicle stopped on the side of a highway for example).

This embodiment also comprises flow regulation means 7 positioned at radial inlets ER2 of second circulation flow F2 passing into at least a second circulation means. These flow regulation means 7 control or block passage of the fluid into the circulation means for passage of flow F2. They can notably open or shut a passage section in “on-off” mode, or open a passage section in a controlled manner, thus providing a more or less large flow passage section according to need. Without limitation, the flow regulation means can be a simple calibrated hole allowing passage of flow F2 under certain pressure/flow rate conditions (passive system), an “on-off” valve (active or passive system), or a regulation valve (active system) such as a ball valve for example.

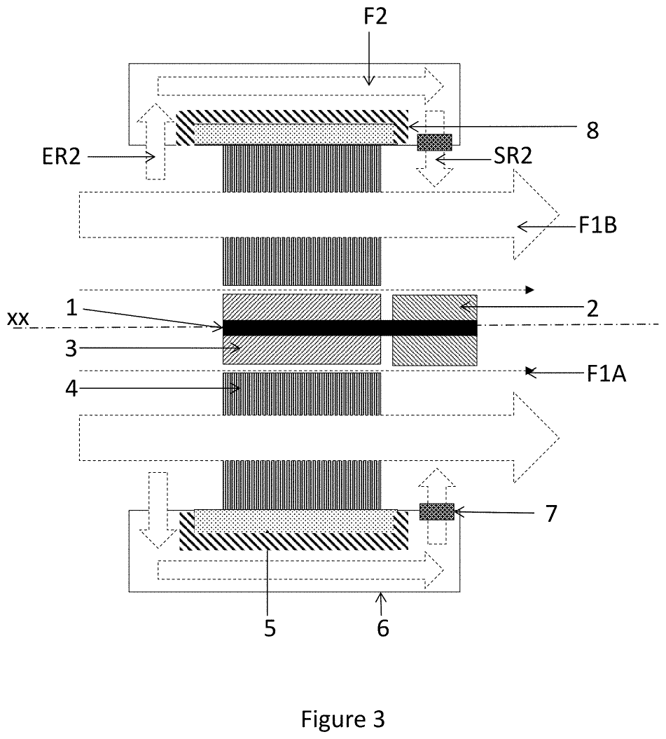

For FIGS. 3 to 5, the references are identical to FIG. 2 and fully correspond to the references of FIG. 2. They are not described in detail in these figures.

FIG. 3 shows a third variant of the electric machine according to the invention. In this figure, the flow regulation means 7 is positioned on radial outlet SR2 of at least a second circulation flow F2. This configuration has the same function as in FIG. 2, which allows or blocks passage of a flow in the second circulation means. Positioning the flow regulation means at the outlet of at least a second flow makes it possible to also integrate a circulation flow orientation means. This orientation means allows both mixing the flows from second circulation flow F2 and from the two parts of first flow F1A and F1B passing through the air gap and the stator, and to impart a pre-rotation, about the axis of rotation, thereto. This pre-rotation of the flow is particularly interesting when a compression device such as a compressor, a fortiori a turbocharger device, is positioned behind the electric machine, thus creating an electrified compressor or an electrified turbocharger. Indeed, this pre-rotation of the flow at the compressor inlet allows the efficiency thereof to be increased. This pre-rotation can for example be induced by blades or pieces of blades.

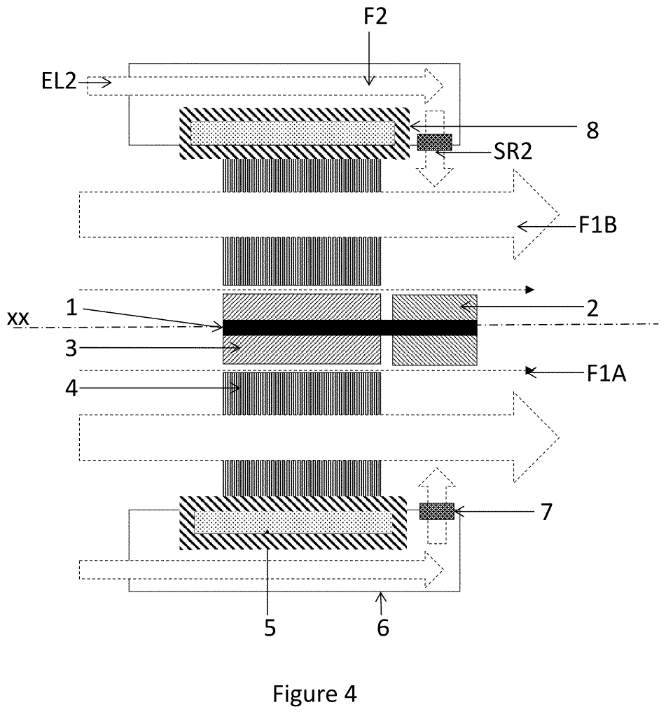

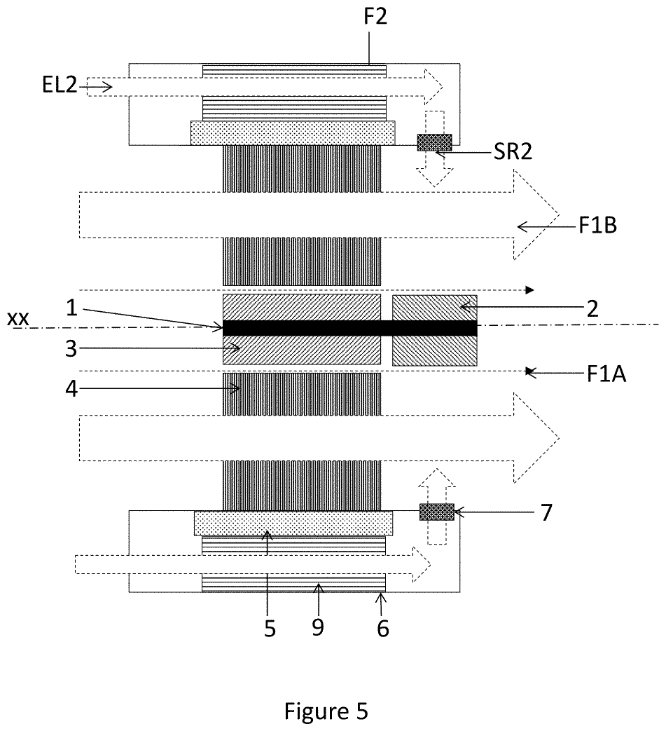

For FIGS. 4 and 5, the references identical to FIG. 3 fully correspond to the references of FIG. 3. They are not described in detail in these figures.

FIG. 4 schematically shows, by way of non-limitative example, a fourth variant of the electric machine according to the invention. This figure differs from FIGS. 1 to 3 above in that the inflow of fluid into the second circulation means no longer occurs radially, but axially. Thus, the electric machine no longer has a single fluid inlet, but rather two fluid inlets. However, the fluid inflows through these two inlets may or may not come from the same fluid stream upstream from the electric machine. It may be for example the same piping whose diameter would include the two axial inlets of the electric machine. The inlet for flow EL2 is therefore axial which is parallel to axis of rotation xx. Axial inlet EL2 reduces pressure drops in relation to a radial inlet.

The outlet of flow F2 remains radial and it is provided with a flow regulation means 7 on radial outlet SR2. The flow regulation means 7 may or may not comprise an outlet flow orientation means for controlling a pre-rotation of the flow.

In FIG. 4, fins 8 are arranged all around magnetic flux generators 5. Indeed, they are positioned both on the outside diameter and at both longitudinal ends of magnetic flux generators, as in FIGS. 2 and 3, and on the inside diameter of magnetic flux generators 5. By entirely surrounding magnetic flux generators 5, fins 8 provide better cooling while increasing the exchange surface area.

FIG. 5 schematically shows, by way of non-limitative example, a fifth variant of the electric machine according to the invention. This figure differs from FIG. 4 in that fins 8 of FIG. 4 are replaced by a secondary cooling system 9. This secondary cooling system can for example be a closed cooling circuit for a fluid, which preferably is a liquid fluid.

The invention is particularly relevant, inter alia, for other applications such as turbines, notably of microturbine or turbogenerator type.

1-13. (canceled)

14. An electric machine comprising a rotor, a stator, an outer casing and a means for cooling the stator, the stator being coaxial along a longitudinal axis, and comprising magnetic flux generators, the means for cooling the stator comprising at least two fluid circulations, at least a first fluid circulation extending longitudinally within the stator and at least a second fluid circulation positioned around the periphery of the stator.

15. An electric machine as claimed in claim 14, wherein stator comprises radial passages circumferentially arranged along the stator and being delimited by radial teeth, the magnetic flux generators being housed in the radial passages with the radial passages forming at least the first fluid circulation facing the magnetic flux generators.

16. The electric machine as claimed in claim 14, wherein the fluid is air at ambient temperature taken from an ambient medium.

17. The electric machine as claimed in claim 15, wherein the fluid is air at ambient temperature taken from an ambient medium.

18. The electric machine as claimed in claim 14, wherein at least the second fluid circulation is arranged between the magnetic flux generators and the outer casing.

19. The electric machine as claimed in claim 16, wherein at least the second fluid circulation is arranged between the magnetic flux generators and the outer casing.

20. The electric machine as claimed in claim 17, wherein at least the second fluid circulation is arranged between the magnetic flux generators and the outer casing.

21. The electric machine as claimed in claim 14, wherein the inlet to the at least second fluid circulation is radial from the at least first circulation means.

22. The electric machine as claimed in claim 14, wherein the inlet of the at least second fluid circulation is axial.

23. The electric machine as claimed in claim 14, wherein the outlet of the second fluid circulation is radial.

24. The electric machine as claimed in claim 14, wherein the outlet of the second fluid circulation is axial.

25. The electric machine as claimed in claim 23, wherein the second fluid circulation comprises at the outlet thereof means for providing a radial orientation of the fluid flow for mixing the fluids circulating in the at least two fluid circulations.

26. The electric machine as claimed in claim 14, wherein the second fluid circulation comprises an active or passive flow regulation positioned at the inlet or at the outlet of the second fluid circulation.

27. The electric machine as claimed in claim 14, wherein the second fluid circulation comprises fins at the second fluid circulation which extend from one end to an other end of the second fluid circulation which are orthogonal to a direction of flow of fluid in the second fluid circulation.

28. A compression device for a fluid, comprising a compressor with an intake for the fluid to be compressed, an outlet for the compressed fluid, the compressor being carried by a compressor shaft and housed between the intake and the outlet, and an electric machine as claimed in claim 14 wherein the electric machine is positioned upstream in relation to a direction of fluid flow from the compressor.

29. An electrified turbocharger device comprising an expansion device and a compression as claimed in claim 28, the expansion device and the compressor are both connected to rotating shaft to provide common rotation of the expansion device and a single compressor.
